(19) United States
(12) Patent Application Publication
(10) Pub. No.: US 2006/0070009 A1
(43) Pub. Date: Mar. 30, 2006

(54) Key-controlled multi-level window activating method and interface

(76) Inventors: Chaucer Chiu, Taipei (TW); Anthony Zhou, Taipei (TW)

Correspondence Address: Mr. Joseph A. Sawyer, Jr.;SAWYER LAW GROUP LLP, Embarcadero Corporate Center, Suite 406, 2465 East Bayshore Road, Palo Alto, CA, 94303, US

(21) Appl. No.: 10/996,929

(22) Filed: Nov. 24, 2004

(30) Foreign Application Priority Data
Sep. 27, 2004 (TW) 093129378

(51) Int. Cl. G06F 17/00

(52) U.S. Cl. 715/797

(57) ABSTRACT

A key-controlled multi-level window activating method and interface is proposed, which is designed for use in conjunction with a window-based information platform for providing the user with a key-controlled multi-level window activating capability that allows the user to utilize keyboard keys, rather than mouse in the case of prior art, to activate each window in a hierarchical window system. This feature allows the user to open windows in a hierarchical window system more accurately and user-friendly without the drawback of inconvenient and unreliable use of mouse cursor as in the case of prior art.

### BACKGROUND OF THE INVENTION

1. Field of the Invention

This invention relates to information technology (IT), and more particularly, to a key-controlled multi-level window activating method and interface which is designed for use in conjunction with a window-based information platform (i.e., a computer system installed with a window-based operating system), such as a desktop computer, a notebook computer, a tablet computer, a PDA (Personal Digital Assistant) unit, or the like, for providing the user with a key-controlled multi-level window activating capability that allows the user to utilize keyboard keys, rather than mouse, to activate (i.e., open) and deactivate (i.e., close) each window in a hierarchical window system.

2. Description of Related Art

Nowadays, information platforms such as desktop computers, notebook computers, tablet computers, PDA (Personal Digital Assistant) units, and so on, are typically installed with a window-based operating system that offers a graphic user interface for the user to operate the information platform more conveniently and user-friendly.

Online English-Chinese dictionary is a widely-used application on various information platforms, which typically utilizes a hierarchical window system to display an English word in a first-level window (or called parent window) and its various definitions in Chinese and usage examples in bottom-level windows (or called child windows).

FIGS. 1A-1B show an example of a hierarchical window system 20 that is utilized on a conventional online English-Chinese dictionary, which includes, for example, three levels of windows including a first-level window 21 (i.e., the topmost-level window, or called parent window), a second-level window 22 (or called a child window of the first-level window 21), and a third-level window 23 (i.e., the bottommost-level window, or called a child window of the second-level window 22).

As shown in FIG. 1A, when the user is utilizing the online English-Chinese dictionary to look up the English word [take], a first-level window 21 will be displayed to show the English word [take] along with its pronunciation and various definitions in Chinese. In addition, the first-level window 21 displays an array of graphic buttons 31, each of which corresponds to one of a number of second-level windows 22 and can be selected by using a mouse to open a corresponding second-level window 22 as shown in FIG. 2B to display a further set of definitions of the English word [take] in Chinese. In a similar manner, the second-level window 22 also includes an array of graphic buttons 32, each of which corresponds to one of a number of third-level windows 23 and can be selected by using a mouse to open a corresponding third-level window 23 as shown in FIG. 1B to display a set of usage examples of each different definition of the English word [take] in Chinese. Through this 3-level hierarchical window system, the user can learn the Chinese definitions and related data of each English word in an organized manner.

In actual application, however, one drawback to the operation of the foregoing hierarchical window system 20 is that a mouse is used to select the desired one of the graphic buttons 31, 32, and since these graphic buttons 31, 32 are typically very small in size, the user would have difficulties in precisely pin-pointing the desired one of the graphic buttons 31, 32. In the event that the user fails to pin-point the mouse cursor precisely at the desired graphic button (i.e., if the mouse cursor is pointed at a position beyond the areas occupied by the first-level window 21 or the second-level window 22), it would cause the first-level window 21 or the second-level window 22 to disappear from screen, making the user-operation of the hierarchical window system 20 very inconvenient and bothersome.

### SUMMARY OF THE INVENTION

It is therefore an objective of this invention to provide a key-controlled multi-level window activating method and interface for use with a window-based information platform to allow the user to utilize keyboard keys, rather than mouse, to select graphic buttons in each window in a hierarchical window system, so that the user-operation of the hierarchical window system can be made more conveniently and accurately.

The key-controlled multi-level window activating method and interface according to the invention is designed for use in conjunction with a window-based information platform (i.e., a computer system installed with a window-based operating system), such as a desktop computer, a notebook computer, a tablet computer, a PDA (Personal Digital Assistant) unit, or the like, for providing the user with a key-controlled multi-level window activating capability that allows the user to utilize keyboard keys, rather than mouse, to activate (i.e., open) and deactivate (i.e., close) each window in a hierarchical window system.

The key-controlled multi-level window activating method and interface according to the invention is characterized by that it allows the user to reliably make a selection on a desired graphic button to activate a window in a hierarchical window system by means of keyboard keys, rather than mouse in the case of the prior art. This feature allows the user to operate the hierarchical window system more accurately and user-friendly than prior art.

### BRIEF DESCRIPTION OF DRAWINGS

The invention can be more fully understood by reading the following detailed description of the preferred embodiments, with reference made to the accompanying drawings, wherein:

FIG. 1A is a schematic diagram showing an example of a screen display of a first-level window in a hierarchical window system used by a conventional online English-Chinese dictionary;

FIG. 1B is a schematic diagram showing an example of a screen display of a second-level window and a third-level window that are associated with the first-level window shown in FIG. 1A;

FIG. 2 is a schematic diagram showing the application architecture and object-oriented component model of the key-controlled multi-level window activating interface of the invention;

FIG. 3 is a schematic diagram showing an example of a hierarchical window system under control by the key-controlled multi-level window activating interface of the invention.

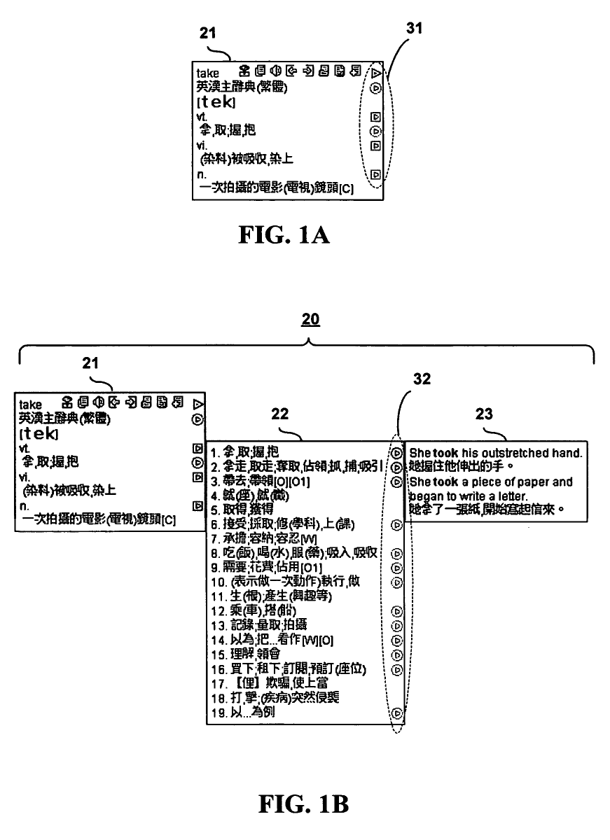

### DETAILED DESCRIPTION OF PREFERRED EMBODIMENTS

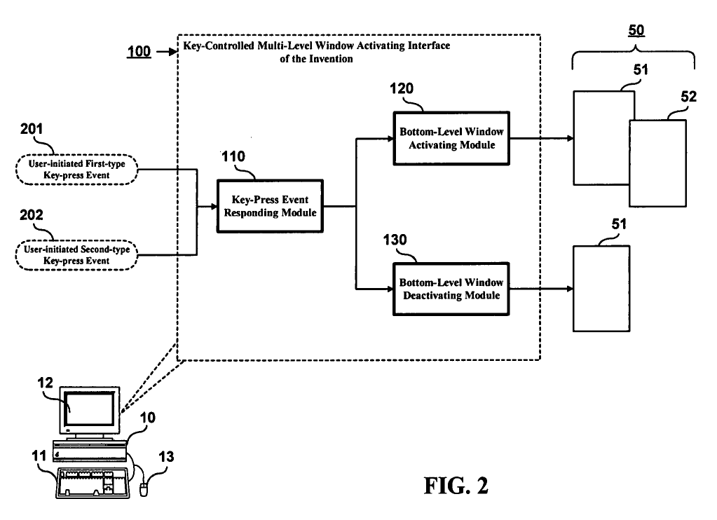

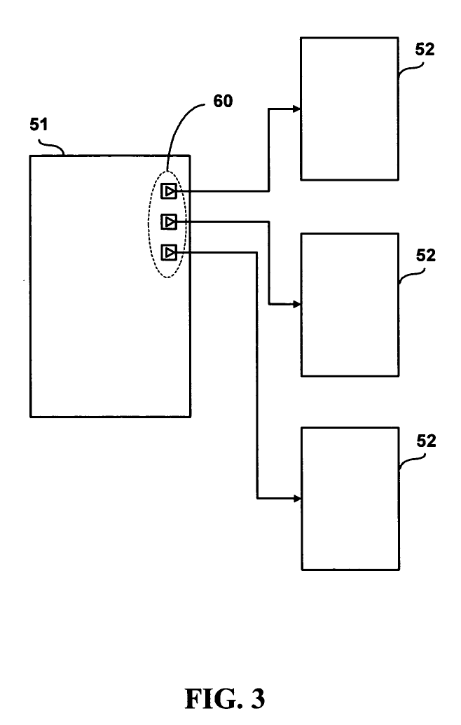

The key-controlled multi-level window activating method and interface according to the invention is disclosed in full details by way of preferred embodiments in the following with reference to FIG. 2 and FIG. 3.

FIG. 2 is a schematic diagram showing the application architecture and object-oriented component model of the key-controlled multi-level window activating interface according to the invention (as the part enclosed in the dotted box indicated by the reference numeral 100). As shown, the key-controlled multi-level window activating interface of the invention 100 is designed for use with in conjunction with a window-based information platform 10 (i.e., a computer system installed with a window-based operating system that offers a hierarchical window system 50), such as a desktop computer, a notebook computer, a tablet computer, a network workstation, a PDA (Personal Digital Assistant) unit, or the like, for providing the user with a key-controlled multi-level window activating capability that allows the user to utilize a keyboard 11, rather than a mouse 13, to activate each window in the hierarchical window system 50 displayed on the screen 12.

In the following example, it is assumed that the hierarchical window system 50 includes a top-level window (or called parent window) 51 and a number of bottom-level windows (or called child windows) 52 associated with the top-level window 51. In actual applications, however, the hierarchical window system 50 can include more levels of bottom-level windows, such as 3, 4, 5, or more levels.

In practical implementation, the key-controlled multi-level window activating interface of the invention 100 can be fully realized by software and integrated as an add-on module to a window-based operating system or application that is installed on the information platform 10, such as an online English-Chinese dictionary.

As shown in FIG. 2, the object-oriented component model of the key-controlled multi-level window activating interface of the invention 100 comprises: (a) a key-press event responding module 110; (b) a bottom-level window activating module 120; and (c) a bottom-level window deactivating module 130.

The key-press event responding module 110 is capable of responding to various user-initiated key-press events on the keyboard 11 of the information platform 10, including a first-type key-press event 201 and a second-type key-press event 202, by sending the received key-press messages from the keyboard 11 that are generated in response to either the first-type key-press event 201 or the second-type key-press event 202 respectively to the bottom-level window activating module 120 or the bottom-level window deactivating module 130.

The bottom-level window activating module 120 is capable of displaying an array of graphic buttons 60 as shown in FIG. 3 in the top-level window 51 displayed on the screen 12, wherein each graphic button 60 is associated with one of a number of bottom-level windows 52 that are associated with the top-level window 51. In actual use, the bottom-level window activating module 120 is capable of responding to a user-initiated first-type key-press event 201 received by the key-press event responding module 110 to select a corresponding graphic button 60 in the top-level window 51 for the purpose of activating (i.e., opening) the corresponding one of the bottom-level windows 52. In actual realization, the first-type key-press event 201 can be for example implemented by first manually pressing an upper-shift key [↑] or a down-shift key [↓] on the keyboard 11 to select the desired one of the graphic buttons 60 (at this time, the selected one of the graphic buttons 60 will be indicated by, for example, changing its color or brightness), and then manually pressing a certain key, such as the [Enter] key or right-shift key [→] on the keyboard 11.

The bottom-level window deactivating module 130 is capable of being enabled after a certain bottom-level window 52 has been activated into active status by the bottom-level window activating module 120, and which is capable of responding to a user-initiated second-type key-press event 202 received by the key-press event responding module 110 to deactivate (i.e., closing) the currently-active bottom-level window 52. In actual realization, the second-type key-press event 202 can be implemented by, for example, manually pressing a certain key, such as the [Esc] key or left-shift key [←] on the keyboard 11.

Referring to FIG. 2 together with FIG. 3, in practical application, the user can utilize the information platform 10 to operate a window-based operating system or application, such as an online English-Chinese dictionary.

When the information platform 10 displays a top-level window 51 on the screen 12 and if the user wants to activate a certain bottom-level window 52 associated with the top-level window 51, then the user needs to utilize the keyboard 11 (rather than the mouse 13 as in the case of prior art) to initiate a first-type key-press event 201, which is carried out by first manually pressing the upper-shift key [↑] or the down-shift key [↓] on the keyboard 11 to select the desired one of the graphic buttons 60 that corresponds to the desired bottom-level window 52, and then manually pressing a certain key, such as the [Enter] key or right-shift key [→] on the keyboard 11. This action causes the key-press event responding module 110 to respond to the first-type key-press event 201 by sending the received key press message from the keyboard 11 to the bottom-level window activating module 120, causing the bottom-level window activating module 120 to respond by activating the bottom-level window 52 that is associated with the user-selected graphic button 60.

On the other hand, after a certain bottom-level window 52 has been activated and if the user wants to deactivate (i.e., close) that bottom-level window 52, then the user needs just to utilize the keyboard 11 to initiate a second-type key-press event 202, which is carried out by manually pressing a certain key, such as the [Esc] key or left-shift key [←] on the keyboard 11. This action causes the key-press event responding module 1 10 to respond by sending the received key press message to the bottom-level window deactivating module 130, causing the bottom-level window deactivating module 130 to respond by deactivating the currently-active bottom-level window 52.

In conclusion, the invention provides a key-controlled multi-level window activating method and interface which is designed for use in conjunction with a window-based information platform for providing the user with a key-controlled multi-level window activating capability that allows the user to utilize keyboard keys, rather than mouse, to activate each window in a hierarchical window system. This feature allows the user to operate the hierarchical window system more accurately and user-friendly than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A key-controlled multi-level window activating method for use on an information platform having a hierarchical window system that includes a top-level window and at least one bottom-level window associated with the top-level window, for providing a user-operated key-controlled activating function for the hierarchical window system;
the key-controlled multi-level window activating method comprising:
in the event that a top-level window is being displayed on the information platform, displaying an array of graphic buttons in the top-level window wherein each graphic button is associated with one bottom-level window;
responding to a user-initiated first-type key-press event by selecting a corresponding graphic button in the top-level window to thereby activate the bottom-level window that is associated with the user-selected graphic button; and
responding to a user-initiated second-type key-press event by deactivating the currently-active bottom-level window.

2. The key-controlled multi-level window activating method of claim 1, wherein the information platform is a desktop computer.

3. The key-controlled multi-level window activating method of claim 1, wherein the information platform is a notebook computer.

4. The key-controlled multi-level window activating method of claim 1, wherein the information platform is a tablet computer.

5. The key-controlled multi-level window activating method of claim 1, wherein the information platform is a PDA (Personal Digital Assistant) unit.

6. The key-controlled multi-level window activating method of claim 1, wherein the information platform is a network workstation.

7. A key-controlled multi-level window activating interface for use with an information platform having a hierarchical window system that includes a top-level window and at least one bottom-level window associated with the top-level window, for providing a user-operated key-controlled activating function for the hierarchical window system;
the key-controlled multi-level window activating interface comprising:
a key-press event responding module, which is capable of responding to each key-press event on the information platform by receiving the key press message activated by each key-press event;
a bottom-level window activating module, which is capable of displaying an array of graphic buttons in the top-level window wherein each graphic button is associated with one bottom-level window, and which is capable of responding to a user-initiated first-type key-press event received by the key-press event responding module by selecting a corresponding graphic button in the top-level window to thereby activate the bottom-level window that is associated with the user-selected graphic button; and
a bottom-level window deactivating module, which is capable of being enabled after a bottom-level window has been activated by the bottom-level window activating module, and which is capable of responding to a user-initiated second-type key-press event received by the key-press event responding module to deactivate the currently-active bottom-level window.

8. The key-controlled multi-level window activating interface of claim 7, wherein the information platform is a desktop computer.

9. The key-controlled multi-level window activating interface of claim 7, wherein the information platform is a notebook computer.

10. The key-controlled multi-level window activating interface of claim 7, wherein the information platform is a tablet computer.

11. The key-controlled multi-level window activating interface of claim 7, wherein the information platform is a network workstation.

12. The key-controlled multi-level window activating interface of claim 7, wherein the information platform is a network workstation.
